(19) United States
(12) Patent Application Publication
(10) Pub. No.: US 2018/0113233 A1
(43) Pub. Date: Apr. 26, 2018

(54) DETERMINATION OF CONCENTRATION OF CHEMICAL ELEMENTS IN AN EARTH FORMATION FROM NON-COAXIAL DUAL DETECTOR RADIATION MEASUREMENTS

(71) Applicant: BAKER HUGHES INCORPORATED, Houston, TX (US)

(72) Inventors: ALEXANDR ANATOLEVICH VINOKUROV, Novosibirsk (RU); BAIR VALERYEVICH BANZAROV, Novosibirsk (RU); NIKOLAY NIKOLAEVICH VELKER, Novosibirsk (RU); NIKOLAI ALEKSANDROVIC SIMONOV, Novosibirsk (RU)

(73) Assignee: BAKER HUGHES INCORPORATED, Houston, TX (US)

(21) Appl. No.: 15/502,578

(22) PCT Filed: Dec. 15, 2015
(86) PCT No.: PCT/RU2015/000885

§ 371 Date: Feb. 8, 2017

(51) Int. Cl. G01V 5/04

(52) U.S. Cl. CPC G01V 5/04

(57) ABSTRACT

Methods and devices for evaluating earth formations. Methods include making a plurality of radiation measurements with a GR detector disposed on a carrier in the borehole and a second GR detector disposed on the carrier by positioning the first GR detector and the second GR detector in the borehole at each borehole depth such that the first GR detector is radially offset from the second GR detector with respect to the longitudinal axis of the borehole; making an estimate of a concentration of at least one chemical element in the formation for each borehole depth for each of the first GR detector and the second GR detector from the plurality of measurements; and estimating an actual concentration of the at least one chemical element using the estimates of the concentration for the first GR detector and the estimates of the concentration for the second GR detector for each borehole depth.

### FIELD OF THE DISCLOSURE

This disclosure generally relates to borehole logging methods and apparatuses for estimating formation properties using nuclear radiation based measurements.

### BACKGROUND OF THE DISCLOSURE

Oil well logging has been known for many years and provides an oil and gas well driller with information about the particular earth formation being drilled. In conventional oil well logging, during well drilling and/or after a well has been drilled, a nuclear radiation sensor comprising one or more detectors may be conveyed into the borehole and used to determine one or more parameters of interest of the formation. A rigid or non-rigid conveyance device is often used to convey the nuclear radiation sensor, often as part of a tool or a set of tools, and the carrier may also provide communication channels for sending information up to the surface.

### SUMMARY OF THE DISCLOSURE

In aspects, the present disclosure is related to methods and apparatus for estimating a parameter of interest of a formation using radiation detected from a subterranean formation.

Aspects of the disclosure include methods of evaluating an earth formation intersected by a borehole. Method embodiments may include making a plurality of radiation measurements at plurality of borehole depths with a first gamma ray (GR) detector disposed on a carrier in the borehole and a second GR detector disposed on the carrier by positioning the first GR detector and the second GR detector in the borehole at each borehole depth such that the first GR detector is radially offset from the second GR detector with respect to the longitudinal axis of the borehole; making an estimate of a concentration of at least one chemical element in the formation for each borehole depth for each of the first GR detector and the second GR detector from the plurality of measurements; and estimating an actual concentration of the at least one chemical element using the estimates of the concentration for the first GR detector and the estimates of the concentration for the second GR detector for each borehole depth.

Methods may also include estimating for each borehole depth a gamma ray spectrum for each of the first GR detector and the second GR detector; making the estimate of the concentration for each borehole depth for each of the first GR detector and the second GR detector by deconvolving a corresponding gamma ray spectrum into a corresponding plurality of elemental spectral yields; and estimating the actual concentration by curve fitting the estimates of the concentration for the first GR detector with respect to the estimates of the concentration for the second GR detector for each borehole depth.

Deconvolving the corresponding gamma ray spectrum may include using standards-based decomposition. A standard representing radiation of one of the at least one chemical element for the first OR detector may be different than a standard representing radiation of the one of the at least one chemical element for the second GR detector. At least one of the gamma ray spectra may be predominantly representative of naturally occurring radiation from the formation. The first detector may be axially separated from the second detector. Positioning the first GR detector and the second GR detector may include eccentering the carrier in the borehole. The first detector may be closer to a longitudinal axis of the borehole than the second detector, and the second detector may be closer to a wall of the borehole than the first detector, while making one of the plurality of radiation measurements.

The tool may include radiation shielding positioned to prevent incident radiation from reaching a radiation-shaded portion of the first detector oriented toward the wall while allowing other incident radiation to reach a second portion of the first detector oriented toward the longitudinal axis. The tool may include radiation shielding positioned to prevent incident radiation from reaching a radiation-shaded portion of the second detector oriented toward the longitudinal axis while allowing other incident radiation to reach a second portion of the second detector oriented toward the wall. The radiation measurements of the first detector may be predominantly representative of incident radiation from the borehole and the radiation measurements of the second detector may be predominantly representative of incident radiation from the formation. The radiation measurements may be substantially independent of a density of the formation.

In some aspects, methods may include generating data points by plotting the estimates of the concentration for the first GR detector with respect to the estimates of the concentration for the second GR detector; finding a line for the data points having a best fit; and determining a point on the line wherein the concentration for the first GR detector is equal to the concentration for the second GR detector.

Other aspects include an apparatus for evaluating an earth formation. Apparatus embodiments may include a tool configured to make a plurality of radiation measurements at plurality of borehole depths with a first gamma ray (GR) detector disposed on a carrier in the borehole and a second GR detector disposed on the carrier by positioning the first OR detector and the second GR detector in the borehole at each borehole depth such that the first GR detector is radially offset from the second GR detector with respect to the longitudinal axis of the borehole; and at least one processor configured to make an estimate of a concentration of at least one chemical element in the formation for each borehole depth for each of the first OR detector and the second GR detector from the plurality of measurements; and estimate an actual concentration of the at least one chemical element using the estimates of the concentration for the first GR detector and the estimates of the concentration for the second GR detector for each borehole depth. The processor may be configured by providing access to computer readable program instructions disposed upon a non-transitory computer readable medium. The processor may perform methods described above in response to executing the computer readable program instructions.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 schematically illustrates a system having a downhole tool configured to acquire information in a borehole intersecting an earth formation in accordance with embodiments of the present disclosure;

FIGS. 2A-2C show a nuclear detection module that may be incorporated in a downhole tool in accordance with embodiments of the present disclosure;

FIGS. 3A & 3B illustrate computer modeled contributions of different sources to the detectors of the tool in accordance with embodiments of the present disclosure according to a simulated system;

FIG. 4 shows a number of counts for a 1.46 MeV energy level with respect to various formation densities while holding mass concentration of potassium fixed;

FIG. 5 shows a flow chart of a method for estimating at least one parameter of interest of the earth formation in accordance with embodiments of the present disclosure;

FIG. 6 illustrates techniques for estimating clay type in accordance with embodiments of the present disclosure;

FIG. 7 is a schematic diagram of an exemplary drilling system in accordance with embodiments of the present disclosure.

### DETAILED DESCRIPTION

In aspects, this disclosure relates to evaluation of an earth formation using naturally occurring radiation from the formation. In some aspects, this disclosure relates to estimating a parameter of interest of the formation. The parameter of interest may be a physical characteristic of the formation.

In aspects, the present disclosure is directed to a dual detector nuclear spectroscopy logging tool which registers gamma-quanta emitted by natural radionuclides. Information obtained by the tool may be used to determine the concentration of natural radionuclides in an earth formation and in the borehole fluid. The tool may include axially offset non-coaxial scintillation detectors which may include collimated shielding made of high-density material. The tool may be positioned such that the detectors are radially offset with one another with respect to the longitudinal axis of the borehole. Thus, a first detector (DB) is radially closer to the longitudinal axis of the borehole and faces the borehole (e.g., is closer to the borehole and has no shielding on the borehole side), while a second detector (DF) is radially farther from the longitudinal axis of the borehole and faces the formation (e.g., is closer to the formation and has no shielding on the formation side). For any given measurement, the particular detector which is closest to the longitudinal axis may change.

In other aspects, the radiation measurements taken by each detector are processed to evaluate and characterize the formation. General method embodiments include making a plurality of radiation measurements at plurality of borehole depths with a first gamma ray (GR) detector and a second GR detector as described above by positioning the first GR detector and the second GR detector in the borehole at each borehole depth such that the first GR detector is radially offset from the second GR detector with respect to the longitudinal axis of the borehole; making an estimate of a concentration of at least one chemical element in the formation for each borehole depth for each of the first GR detector and the second OR detector from the plurality of measurements; and estimating an actual concentration of the at least one chemical element using the estimates of the concentration for the first GR detector and the estimates of the concentration for the second OR detector for each borehole depth. In particular implementations, methods may include estimating for each borehole depth a gamma ray spectrum for each of the first GR detector and the second GR detector; making the estimate of the concentration for each borehole depth for each of the first GR detector and the second GR detector by deconvolving a corresponding gamma ray spectrum into a corresponding plurality of elemental spectral yields; and estimating the actual concentration by curve fitting the estimates of the concentration for the first GR detector with respect to the estimates of the concentration for the second GR detector for each borehole depth.

Herein, the terms “nuclear radiation” and “radiation emission” include particle and non-particle radiation emitted by atomic nuclei during nuclear processes (such as radioactive decay and/or nuclear bombardment), which may include, but are not limited to, photons from neutron inelastic scattering and from neutron thermal capture reactions, neutrons, electrons, alpha particles, beta particles, and pair production photons.

The energy spectrum caused by radioactive decay of radionuclides in the formation may be used to estimate parameters of interest of an earth formation. Decay of radionuclides in the formation from nuclear processes may result in emissions. One or more nuclear radiation detectors disposed along the downhole tool may be configured to generate a signal indicative of nuclear radiation detected (e.g., thermal, epithermal, or other neutrons, gamma rays, etc.).

The energy spectrum may be expressed in terms of magnitude (e.g., gamma ray counts per period of time) as a function of energy. The radioactive decay of radionuclides may produce nuclear radiation that may be detected by radiation detectors. Radionuclides may include naturally occurring radionuclides, such as potassium-40, and the uranium and thorium series, which exist in the earth formation and activated radionuclides, which may include radionuclides activated from the irradiation of nuclides with nuclear radiation.

Illustrative methods for estimating parameters of interest may include the acquiring and utilization of information characterizing radiation from the formation. In some cases, this radiation from the formation may be responsive to irradiation by the apparatus. The information may be acquired by tools deployed into a wellbore intersecting one or more volumes of interest of an earth formation.

For context, an exemplary system for deploying and using such tools to acquire this information is described below. Each of these aspects may be referred to generally as investigation of the formation. The acquired radiation measurement information (‘radiation measurements’) may then be processed to estimate parameters of interest of the formation. The information or the estimated parameters may then be used to better conduct further exploration, development, and production operations in the formation. Unless otherwise noted, figures are not drawn to scale.

Aspects of the present disclosure include taking radiation measurements in the borehole (and thereby generating radiation measurement information) by producing light scintillations from a scintillation material responsive to the absorption of the radiation from the formation by the scintillation material. One or more nuclear radiation detectors disposed along the downhole tool may be configured to generate a response indicative of the nuclear radiation detected. The detected nuclear radiation may include gamma rays.

The detected nuclear radiation may be expressed as an energy spectrum (the “response spectrum”). The response spectrum may be measured over a wide range of energies, resulting in improved estimation of the parameter of interest. For example, the response spectrum may span a continuous energy range including gamma ray photo peaks at characteristic energies associated with respective elements for all of the sample elements. Alternatively, specific energy windows may be used which are best suited for particular techniques or for estimating particular parameters.

Response spectrum refers to not only the response spectrum as originally acquired, but also after filtering, corrections, or pre-processing is applied. Since the energy spectrum may include energy spectrum components from multiple radionuclides, the nuclear radiation information may be separated to identify the energy spectrum components contained with the energy spectrum. In some embodiments, the processing may include, but is not limited to, use of one or more of: (i) a mathematical equation, (ii) an algorithm, (iii) an energy spectrum deconvolution technique, (iv) a stripping technique, (v) an energy spectrum window technique, (vi) a time spectrum deconvolution technique, and (vii) a time spectrum window technique.

The separate energy spectrum components may be used for estimating the concentration of at least one radionuclide in the volume of interest of the earth formation. The estimated concentration of the at least one radionuclide may be used for estimating at least one parameter of interest of the earth formation. The estimation may be performed in multiple stages, such that an earlier stage may process the information for a later stage. One of the stages may include a technique of elemental standards-based spectral decomposition (also known as a yields method).

Elemental standards-based spectral decomposition may use a combination of reference spectra (also called ‘standard spectra’, or ‘standards’), with each reference spectrum multiplied by a respective weighting coefficient. Typically a reference spectrum is included for each element of interest (e.g., an element the concentration of which is desired to be known), or for each element producing significant radiation. Each reference spectrum represents a response curve corresponding to radiation attributable to a particular sample element (e.g., uranium). Deconvolution according to the present disclosure may determine the weighting coefficients resulting in the best fit of the composite to the response spectrum. Deconvolution may be linear or non-linear. These coefficients may be used to determine the portion of the matter of the volume constituted by the sample element.

The standard spectra may be derived from analysis of the samples in a laboratory or on-site, which may be obtained using a variety of methods. In one example, gamma ray measurement of a sample may provide a response spectrum to be used as the reference spectrum (i.e., standard) for that element. Derivation of the respective standards as in the case of natural radiation may be carried out through measurements at facilities such as the API Gamma Ray-Neutron Facility in Houston, Tex. using the various test pits that contain known amounts of K, Th, and U, for example.

As described above, generally, to determine the concentration of natural radionuclides, techniques based on decomposition of a measured spectrum may be used. Accuracy of the results may be significantly influenced by the standard spectra used as the basis for decomposition. For those standard spectra obtained in the same environment in which the decomposed spectrum was measured, the accuracy of the calculated concentration is high and the residual is minimal. In this case, concentrations of radionuclides may linearly depend on the coefficients of deconvolution.

For practical use of this approach, a large database of standard spectra is needed corresponding to different environmental conditions of measurement. It is preferable for the conditions under which the measurements were performed to be known (e.g., density of the drilling fluid, presence of radionuclides in the mud, borehole diameter, presence of casing, presence of a cement sheath and its density, and so on) and used as parameters in processing the information, because the differences in the environments affect the measurements, and thus, the estimation of spectra.

Increasing the number of parameters used to determine the concentration complicates the method and may introduce error. If the additional parameters are not known or estimated with sufficient accuracy, the accuracy of the resulting estimated concentration of radionuclides in the formation may be insufficient for correct evaluation of the formation. The present disclosure addresses these issues of the prior art. General embodiments may include estimating concentrations of radionuclides in the formation based on a novel curve fitting technique applied to measurement information obtained using the axially offset detectors (DF and DB) described above.

Aspects of the present disclosure may relate to nuclear logging (e.g., nuclear density logging) using at least one radiation source apart from the tool. The radiation source may be a gamma ray source in the earth formation. In one example, the source of the radiation may be nuclides irradiated by neutrons.

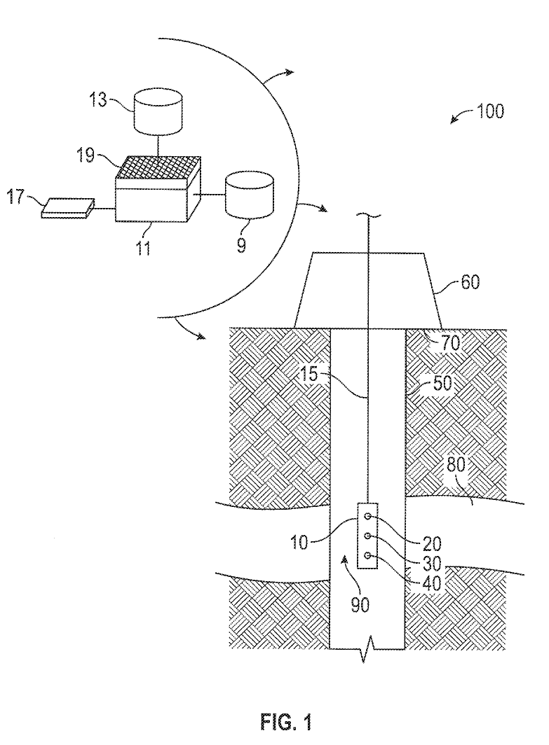

FIG. 1 schematically illustrates a system 100 having a downhole tool 10 configured to acquire information in a borehole 50 intersecting a volume of interest of an earth formation 80 for estimating density, oil saturation, and/or other parameters of interest of the formation 80. The parameters of interest may include information relating to a geological parameter, a geophysical parameter, a petrophysical parameter, and/or a lithological parameter. Thus, the tool 10 may include a sensor array including sensors for detecting physical phenomena indicative of the parameter of interest may include sensors for estimating formation resistivity, dielectric constant, the presence or absence of hydrocarbons, acoustic density, bed boundary, formation density, nuclear density and certain rock characteristics, permeability, capillary pressure, and relative permeability.

The tool 10 may include detectors 20, 30 for detecting radiation (e.g., radiation detectors). Detectors 20, 30 may detect radiation from the borehole, the tool, or the formation. In one illustrative embodiment, the tool 10 may also contain a radiation source 40.

The system 100 may include a conventional derrick 60 and a conveyance device (or carrier) 15, which may be rigid or non-rigid, and may be configured to convey the downhole tool 10 into wellbore 50 in proximity to formation 80. The carrier 15 may be a drill string, coiled tubing, a slickline, an e-line, a wireline, etc. Downhole tool 10 may be coupled or combined with additional tools. Thus, depending on the configuration, the tool 10 may be used during drilling and/or after the borehole (wellbore) 50 has been formed. While a land system is shown, the teachings of the present disclosure may also be utilized in offshore or subsea applications. The carrier 15 may include embedded conductors for power and/or data for providing signal and/or power communication between the surface and downhole equipment. The carrier 15 may include a bottom hole assembly, which may include a drilling motor for rotating a drill bit.

In some embodiments, the optional radiation source 40 emits radiation (e.g., gamma rays or neutrons) into the formation to be surveyed. In one embodiment, the downhole tool 10 may use a pulsed neutron generator emitting 14.2 MeV fast neutrons as its radiation source 40. The use of 14.2 MeV neutrons from a pulsed neutron source is illustrative and exemplary only, as different energy levels of neutrons may be used. In some embodiments, the radiation source 40 may be continuous. In some embodiments, the radiation source 40 may be controllable in that the radiation source may be turned “on” and “off” while in the wellbore, as opposed to a radiation source that is “on” continuously. The measurements performed using this type of radiation may be referred to as “sourceless” measurements since they employ a source that may be turned off, as opposed to a continuously emitting chemical radiation source.

In other embodiments, no source is used, and only the naturally occurring radiation from the formation is estimated. The detectors 20, 30 provide signals that may be used to estimate the radiation counts (e.g., gamma ray counts or neutron counts) returning from the formation. Additional detectors may be used to provide additional radiation information. Two or more of the detectors may be gamma ray detectors. Some embodiments may include radiation shielding (not shown). Drilling fluid 90 may be present between the formation 80 and the downhole tool 10, such that radiation may pass through drilling fluid 90 to reach the detectors 20, 30.

Certain embodiments of the present disclosure may be implemented with a hardware environment that includes an information processor 11, an information storage medium 13, an input device 17, processor memory 19, and may include peripheral information storage medium 9. The hardware environment may be in the well, at the rig, or at a remote location. Moreover, the several components of the hardware environment may be distributed among those locations. The input device 17 may be any data reader or user input device, such as data card reader, keyboard, USB port, etc. The information storage medium 13 stores information provided by the detectors. Information storage medium 13 may include any non-transitory computer-readable medium for standard computer information storage, such as a USB drive, memory stick, hard disk, removable RAM, EPROMs, EAROMs, flash memories and optical disks or other commonly used memory storage system known to one of ordinary skill in the art including Internet based storage. Information storage medium 13 stores a program that when executed causes information processor 11 to execute the disclosed method. Information storage medium 13 may also store the formation information provided by the user, or the formation information may be stored in a peripheral information storage medium 9, which may be any standard computer information storage device, such as a USB drive, memory stick, hard disk, removable RAM, or other commonly used memory storage system known to one of ordinary skill in the art including Internet based storage. Information processor 11 may be any form of computer or mathematical processing hardware, including Internet based hardware. When the program is loaded from information storage medium 13 into processor memory 19 (e.g. computer RAM), the program, when executed, causes information processor 11 to retrieve detector information from either information storage medium 13 or peripheral information storage medium 9 and process the information to estimate a parameter of interest. Information processor 11 may be located on the surface or downhole.

The term “information” as used herein includes any form of information (analog, digital, EM, printed, etc.). As used herein, a processor is any information processing device that transmits, receives, manipulates, converts, calculates, modulates, transposes, carries, stores, or otherwise utilizes information. In several non-limiting aspects of the disclosure, a processor includes a computer that executes programmed instructions for performing various methods. These instructions may provide for equipment operation, control, data collection and analysis and other functions in addition to the functions described in this disclosure. The processor may execute instructions stored in computer memory accessible to the processor, or may employ logic implemented as field-programmable gate arrays (‘FPGAs’), application-specific integrated circuits (‘ASICs’), other combinatorial or sequential logic hardware, and so on.

In other embodiments, such electronics may be located elsewhere (e.g., at the surface, or remotely). To perform the treatments during a single trip, the tool may use a high bandwidth transmission to transmit the information acquired by detectors 20, 30 to the surface for analysis. For instance, a communication line for transmitting the acquired information may be an optical fiber, a metal conductor, or any other suitable signal conducting medium. It should be appreciated that the use of a “high bandwidth” communication line may allow surface personnel to monitor and control the treatment activity in “real time.”

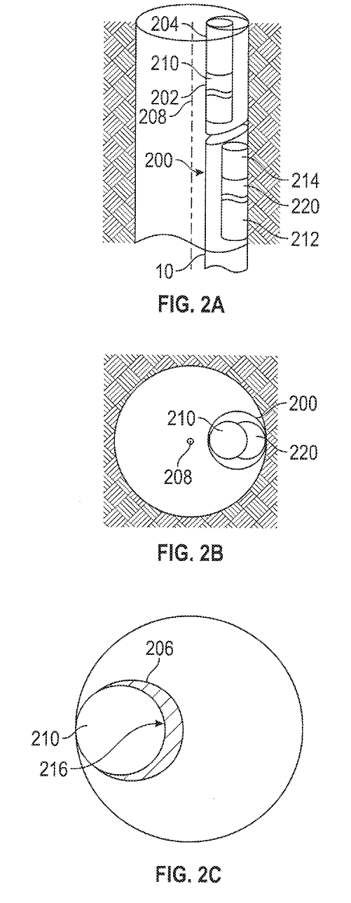

FIGS. 2A-2C show a nuclear detection module 200 that may be incorporated in tool 10, in accordance with embodiments of the present disclosure. FIG. The nuclear detection module 200 may include a first detector 210 and a second detector 220 configured to detect nuclear radiation. The tool 10 (and module 200) is eccentered in the borehole such that, at a borehole depth along the length of the tool, a point on the circumference of the tool is significantly closer to a wall of the borehole (and, thus, significantly farther away from the longitudinal axis of the borehole) than an opposing point across the diameter of the tool. In the implementation shown in FIGS. 2A-2C, this produces a result that the module 200 is positioned to one side of the longitudinal axis 208 of the borehole.

The one or more nuclear radiation sensors 210, 220 may be spaced at different distances along the tool 10 (i.e., vertically offset). Each detector 210, 220 may include a scintillator (e.g., scintillation crystal) 202, 212 producing light scintillations responsive to incident radiation. Scintillators can be made of CsI, BGO, LYSO, B380, LuAG:Pr, or other new highly efficient scintillators. Referring to FIG. 2C, shielding material 206 is used to provide a radiation-shaded region 215 of the detector 210.

The light interacts with a corresponding light detection sensor 204, 214, which includes a light detector and measurement circuitry, such as, for example, a photomultiplier tube (‘PMT’) which produces an electrical (e.g., voltage) signal and at least one processor. As an example, the signal from the PMT may be an analog signal which may run through a preamplifier and analog-to-digital converter (‘ADC’) in turn. The signal emerging from the ADC would be a digital signal, which may be operated on, in turn, by various logic modules. The logic modules may include a pulse shaping module, a pulse detection module, and spectra building module. The logic modules may be implemented in a variety of ways, such as a single a field-programmable gate array (‘FPGA’). The FPGA may then send the spectra to local or remote memory or to a remote subsystem (e.g., a remote processor).

Typically, detectors of a nuclear logging tool were spaced in a substantially linear fashion relative to the radiation source, such that the detectors were substantially coaxial, or spaced at increments around the circumference of the tool in a single measurement plane. However, in embodiments of the present disclosure, the detectors 210, 220 are offset vertically and/or radially. As used herein, radially offset refers to distance between a central longitudinal axis of the detectors along a radius extending from the longitudinal axis of the borehole to the borehole wall. The radial offset of the detectors produces useful differences in the radiation detected by each detector for a measurement (e.g., at a single borehole depth), and thus, in the radiation information as well.

In some embodiments, the detectors may be aligned with opposing vertical faces of the tool (e.g., at points across the diameter of the tool from one another). That is, a point on the periphery of a first detector may be in proximity to the circumference of the tool on a first side of the tool (e.g., toward the interior of the borehole, such as, for example, toward the longitudinal axis of the borehole) while a point on the periphery of a second detector may be in proximity to the circumference of the tool on a second, opposing, side of the tool (e.g., toward the borehole wall, such as, for example, toward the longitudinal axis of the borehole). The cross-sectional footprint of the detectors are shown here to overlap, but may be further separated in other implementations such that no overlap exists.

It should be understood that references to the ‘borehole side’ or the ‘formation side’ of the tool or orientations toward or away from the either the borehole or the borehole wall (or formation) are made with reference to a cross-section of the tool's eccentered orientation. That is, the formation side of the tool is that side of the tool closest to the nearest point on the borehole wall to the tool, and the borehole side of the tool is another side of the tool opposite that side.

In embodiments, each detector registers gamma radiation to a greater or lesser extent from sources located in the rock and from sources located in the borehole fluid. Thus, due to the location of the sensors, and, in some implementations, protection of high-density shielding material (e.g., tungsten alloy), the detectors each have different sensitivities to radionuclides that are in the formation versus those in the borehole fluid. Also, the registration of gamma-quanta by the detectors is influenced by the different absorption properties of the borehole (drilling fluid, casing, cement sheath). These differences may be utilized by novel techniques of the present disclosure, as described in greater detail below.

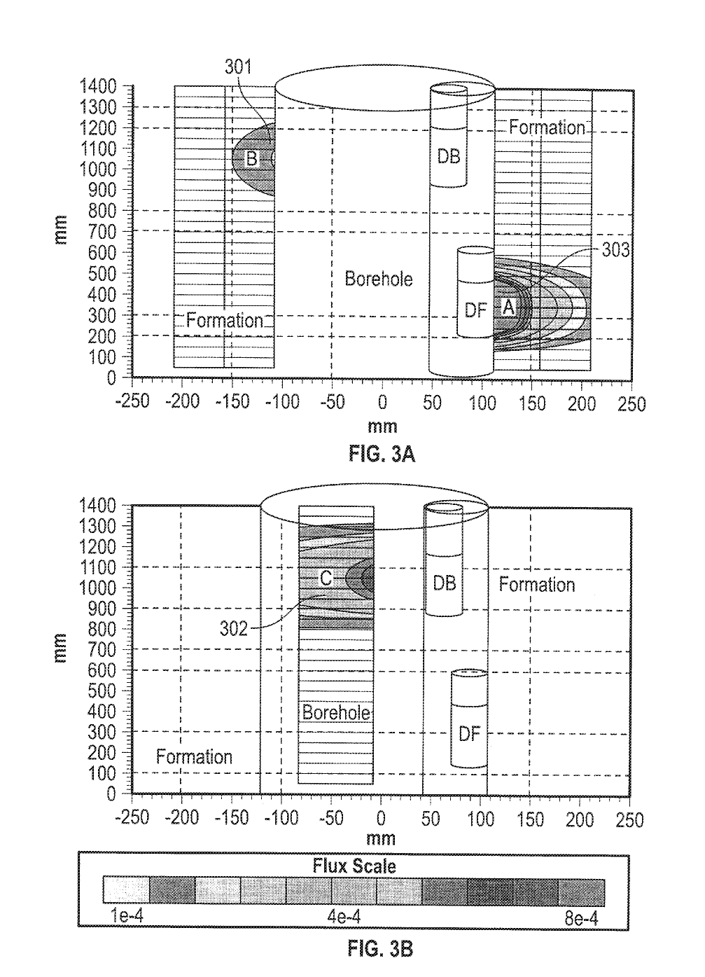

FIGS. 3A & 3B illustrate computer modeled contributions of different sources to the detectors of the tool in accordance with embodiments of the present disclosure according to a simulated system. The formation is sandstone (0 pu, ρ=2.65 g/cm3), and the borehole is filled with fresh water (D=216 mm). In FIG. 3A, sources A and B 301, 303 are located in the formation. That is the sources are dispersed throughout the rock matrix. In FIG. 3B, sources C 302 are located in the borehole, such as, for example, as part of the borehole fluid.

Contributions to the detector measurements (e.g., counts) from various points differ from each other and form a spatial distribution. The simulation results show that the sources located in the rock make significant contributions both to DF detector and to DB detector. At the same time, the sources located in the well substantially fail to contribute to the DF detector readings, but make a significant contribution to the detector DB. Therefore, the detector facing the formation (DF) has a higher sensitivity to gamma radiation from natural radionuclides in the rock. The detector facing the borehole (DB) has a higher sensitivity to gamma radiation from natural radionuclides in the borehole. Further, the absorbing properties of the well have a greater impact on the detector DB than DF. Therefore, the measurements of the tool disclosed herein enable the estimation of concentrations of the natural radionuclides in the rock and in the borehole using techniques described in greater detail below.

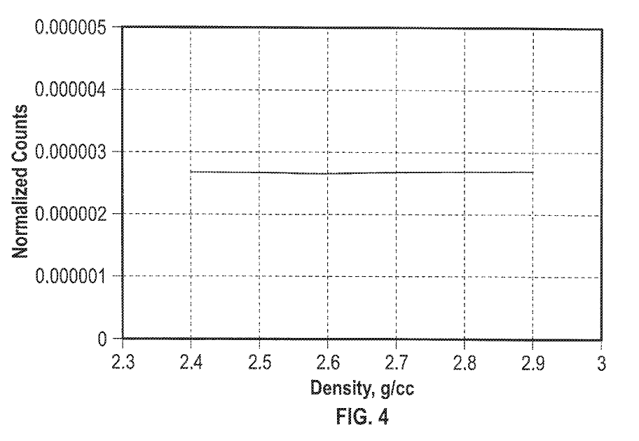

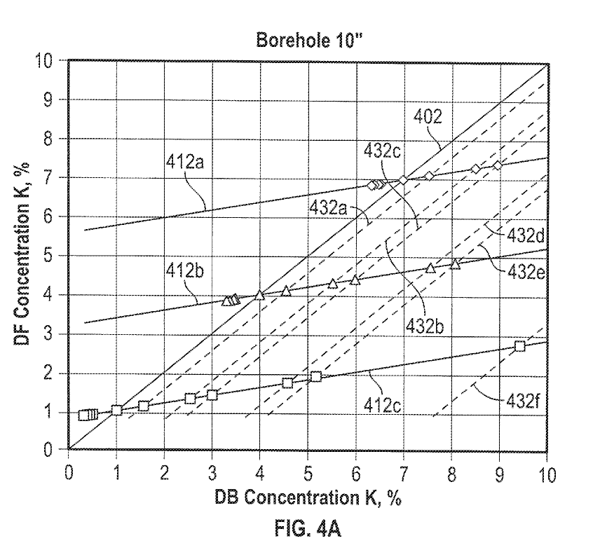

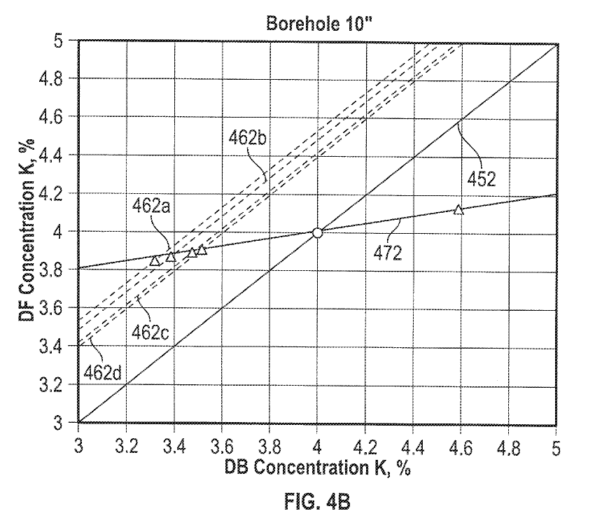

FIG. 4 shows a number of counts for a 1.46 MeV energy level with respect to various formation densities while holding mass concentration of potassium fixed. It is important to note that the measurements of the detectors are substantially independent of the formation density, as illustrated by simulated results from a computer model, as discussed below. FIG. 4 illustrates substantial independence with respect to formation density of the registered number of gamma-quanta in the energy interval characteristic to potassium. It is seen that the density does not affect the readings of the detector. It may be that the increase in the density of the formation reduces gamma-quanta penetration capability, but at the same time, this is offset by increases in concentration of the radionuclides volume. Mutual compensation of these factors results in density independence. Thus, no correction is required for taking into account the formation density when processing the radiation information.

Radiation measurements taken using a tool in accordance with present disclosure, when processed in accordance with the techniques described in further detail herein below, enable increased accuracy and precision when estimations of parameters of interest, such as, for example, actual concentrations of chemical elements in the formation and the borehole.

Using response spectra obtained from the radiation measurements taken at a plurality of borehole depths, decomposition of a measured spectrum into a linear combination of standard spectra is carried out. The standard spectra for the DF detector may be different from (and independent of) the spectra for the DB detector. The registered spectrum and the standard spectra of uranium, thorium, and potassium ((St(U)), St(Th), and St(K), respectively) are measured in the energy range 0.4-3 MeV for both detectors, DF and DB. Such energy range of registered gamma-quanta may be selected to eliminate the influence of lithology on the measured spectra (low-energy part of spectrum is affected by the photoelectric effect). The range of response energies are assigned to n energy channels.

Standard spectra are obtained in the formation with a known concentration of only one radionuclide. These standards are often measured under conditions lacking fluid in the borehole, i.e., the well is “dry”. Since air practically does not absorb gamma rays, the diameter of the hole does not affect the configuration of the standard spectra.

A matrix of standards consists of column spectra for uranium, thorium and potassium in the formation for each detector (DF and DB). The decomposition can be conducted iteratively, solving for each channel (i) in turn. The decomposition can be written as

CFi=St_{F}(K)ᵢ·Q_{F}(K)+St_{F}(U)ᵢ·Q_{F}(U)+St_{F}(Th)ᵢ·Q_{F}(Th), (1)

CBᵢ=St_{B}(K)ᵢ·Q_{F}(K)+St_{B}(U)ᵢ·Q_{F}(U)+St_{B}(Th)ᵢ·Q_{F}(Th), (2)

where
i is the channel index reference, which is an integer representing a channel (energy bin) in the spectrum,
CFᵢ and CBᵢ are counts in the i^{th} channel of the measured spectrum for detectors DF and DB, respectively,
St_{F}(K), St_{F}(U), St_{F}(Th), St_{B}(K), St_{B}(U), St_{B}(Th) are standard column spectra for potassium, uranium and thorium for the detectors DF and DB in a “dry” borehole, each having n components, with each component corresponding to a channel, and

Q_{F}(K), Q_{F}(U), Q_{F}(Th) are mass concentrations of potassium, uranium and thorium, respectively, in a formation.

For each detector, this system of equations can be written generally (in the matrix form):

C=St·Q (3)

or

Q=(St^{T}·R⁻¹·S)⁻¹·S^{T}·R⁻¹·C, (4)

where,
R is the diagonal weight matrix, terms in which are equal to variances of the count rates in the corresponding energy intervals:

$$R = ( \begin{matrix}\sqrt{{C}_{1}} , 0 , … 0 \\ 0 , \sqrt{{C}_{2}} , … 0 \\ … \\ 0 , 0 , … \sqrt{{C}_{n}}\end{matrix} ) .$$

Solution (4) of the over-determined system with respect to Qₙ system of equations (3) may be estimated by finding a best fit, such as, for example, by using the least-squares method. This method minimizes the discrepancy between computed and measured count rates over the whole energy range. This procedure provides the concentrations Q(DF) and Q(DB) for each radionuclide of interest based on response spectra associated with the detectors DF and DB, respectively.

FIGS. 4A & 4B illustrates a plot of values for Q(DF) with respect to Q(DB) for a computer simulation for determination of potassium for the borehole 10 inches in size. For spectra measured in a “dry” borehole, the radionuclides concentrations Q(DF) and Q(DB) calculated by the above technique should coincide and will be equal to the true values of concentration in the formation. The only source of error will be the statistical error of measurements. Therefore, the larger the size of a statistical sample (number of registered gamma-quanta counts in a spectrum), the smaller the statistical uncertainty, and thus the smaller the error in calculated radionuclides concentration.

By simulating measurements of spectra in a “dry” borehole for formations with various concentrations, it is possible to calculate a series of Q(DF) and Q(DB) values from the radiation measurements, and plot the values on a graph, which should be a straight line. This may be referred to as a “mast” 402, 452.

For a fluid present in a borehole, points on the graph for a given concentration will be displaced from the mast and will lie on straight lines, which may be referred to as “spars” 412a-412c, 472. Direction of the displacement (to the right or to the left) will depend on the density of the drilling fluid and on the presence of radionuclides in this fluid. In particular, if there are no radionuclides in the drilling mud, the points on the graph corresponding to Q(DF) and Q(DB) will be located to the left of the mast, since the detectors will determine smaller values of the potassium concentration than that in the dry well. However, if there are radionuclides in the drilling mud, the points on the graph corresponding to Q(DF) and Q(DB) can be located to the right of the mast due to the fact that the detectors can display a concentration higher than the “dry well” value.

FIGS. 4A & 4B show the dependence between Q(DF) and Q(DB) for a test case of determination of potassium for the borehole 10 inches in size. Such dependence can be obtained for other borehole sizes and for other radionuclides as well. FIG. 4A shows the case when the drilling mud contains potassium. FIG. 4B shows the case when the drilling fluid does not contain potassium. In this test case, potassium concentration in the mud was determined by the concentration of KCl and by the density of the drilling fluid. Dashed lines 432a-432f, 462a-462d parallel to the mast 402,452 pass through the points for various concentration values that were obtained for the same mud.

Calculations show that for a given level of potassium in the formation, regardless of the composition of the drilling mud, the point determined by the readings of the detectors DB and DF will lie on the same spar 412a-412c, 472. Thus, it becomes possible to compensate the concentration values in dependence upon the content of the mud, without a priori knowledge.

Below are the parameters of drilling fluids that were used for the computer simulation based on the proposed technology. Density of the drilling mud was increased by addition of the barite weighting agent. The simulation of FIG. 4A used the following drilling mud parameters:

Mud 1—density 1.2 g/cm3 (10 ppg) 10% KCl brine

Mud 2—density 1.68 g/cm3 (14 ppg) 10% KCl brine

Mud 3—density 2.16 g/cm3 (18 ppg) 10% KCl brine

Mud 4—density 1.2 g/cm3 (10 ppg) 20% KCl brine

Mud 5—density 1.68 g/cm3 (14 ppg) 20% KCl brine

Mud 6—density 2.16 g/cm3 (18 ppg) 20% KCl brine

The simulation of FIG. 4B used the following drilling mud parameters:

Mud 1—density 1 g/cm3 (8.34 ppg)

Mud 2—density 1.2 g/cm3 (10 ppg)

Mud 3—density 1.68 g/cm3 (14 ppg)

Mud 4—density 2.16 g/cm3 (18 ppg)

The techniques of the present disclosure for determining the concentration of radionuclides in the formation using the dual detector tool allow elimination of the influence of the drilling mud of various density, elimination of the influence of the presence of radionuclides in the mud, and simplification of the workflow for corrections addressing borehole conditions.

Normalization may be carried out using predicted formation lithology established from neutron induced gamma spectroscopy, porosity, or NMR logs, or the like, either individually or in combination. Predicted formation lithology may include predicted formation mineralogy, porosity and fluids. It is well known to estimate the nuclear density of oxygen, carbon and other relevant elements in dependence upon such information.

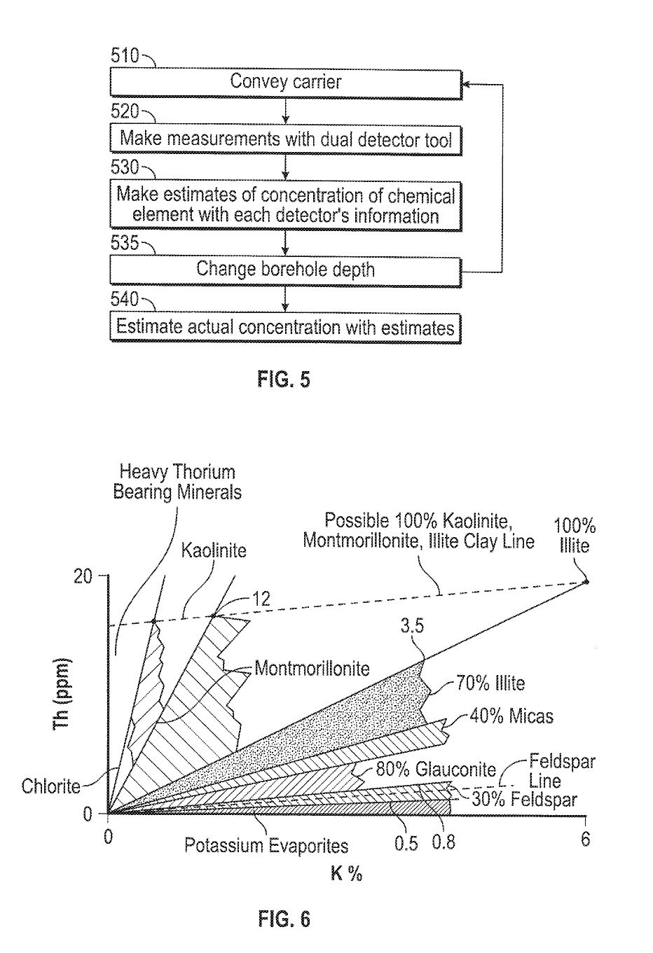

FIG. 5 shows a flow chart 500 for estimating at least one parameter of interest of the earth formation according to one embodiment of the present disclosure. In optional step 510, a carrier on which is disposed a nuclear measurement tool may be conveyed in the borehole to a first borehole depth. In step 520, measurements are made with a first gamma ray (GR) detector disposed on a carrier in the borehole and a second GR detector disposed on the carrier. The measurement may be carried out by positioning the first GR detector and the second GR detector in the borehole at each borehole depth such that the first GR detector is radially offset from the second GR detector with respect to the longitudinal axis of the borehole and performing detection. Detection may occur when the one or more nuclear radiation sensors 210, 220 may generate radiation information in the form of signals in response to light responsive to incident nuclear radiation emissions. In some implementations, the signals representing nuclear radiation may be normalized by applying a correction factor. The correction factor may be determined, for example, in dependence upon an estimated lithology of the formation containing the radionuclide and a model relating lithology to the parameter of interest.

Step 530 includes making an estimate of a concentration of at least one chemical element in the formation for each borehole depth for each of the first GR detector and the second GR detector from the plurality of measurements. This may include estimating for each borehole depth a gamma ray spectrum for each of the first GR detector and the second GR detector; making the estimate of the concentration for each borehole depth for each of the first GR detector and the second GR detector by deconvolving a corresponding gamma ray spectrum into a corresponding plurality of elemental spectral yields; and estimating (determining) the actual concentration by curve fitting the estimates of the concentration for the first GR detector with respect to the estimates of the concentration for the second GR detector for each borehole depth. Deconvolving the corresponding gamma ray spectrum may be carried out using standards-based decomposition. Standards for chemical elements may be different for the first GR detector than the second GR detector.

Step 540 includes estimating an actual concentration of the at least one chemical element using the estimates of the concentration for the first GR detector and the estimates of the concentration for the second GR detector for each borehole depth. Additional parameters of interest may be estimated using the actual concentration. In some embodiments, estimation of the parameter of interest may involve applying a model.

For reservoir characterization, it is desirable to have information available on characteristics of the clay content of the formation. Reservoir filtration properties and its capacity are highly affected by the clay behavior, which depends on the type of clay.

FIG. 6 illustrates techniques for estimating clay type in accordance with embodiments of the present disclosure. U. Th and K are determined from cores for each formation and relationship between U, Th and K and types of clay. The type of clay in its natural occurrence can be determined based on the ratio of natural radionuclide concentrations, such as, for example, the ratios U/K, U/Th, K/Th.

These ratios are empirical. For the same types of clay, but of different geological features, the ratio can be different. Alternatively, or additionally cross plots of these elements may be used to determine clay types. See for example, D. V. Ellis, J. M. Singer, Well Logging for Earth Scientists (2008).

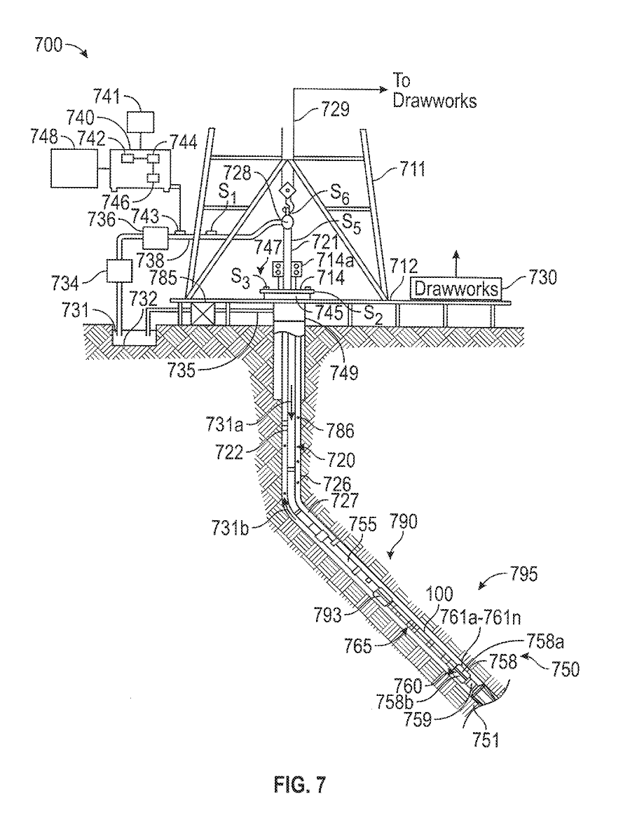

Each of the embodiments herein may be used in a variety of settings in both drilling and non-drilling environments. In some implementations, the disclosed embodiments may be used as part of a drilling system. FIG. 7 is a schematic diagram of an exemplary drilling system 100 that includes a drill string in accordance with embodiments of the disclosure. FIG. 7 shows a drill string 720 that includes a drilling assembly or bottomhole assembly (BHA) 790 conveyed in a borehole 726. The drilling system 700 includes a conventional derrick 711 erected on a platform or floor 712 which supports a rotary table 714 that is rotated by a prime mover, such as an electric motor (not shown), at a desired rotational speed. A tubing (such as jointed drill pipe 722), having the drilling assembly 790, attached at its bottom end extends from the surface to the bottom 751 of the borehole 726. A drill bit 750, attached to drilling assembly 790, disintegrates the geological formations when it is rotated to drill the borehole 726. The drill string 720 is coupled to a drawworks 730 via a Kelly joint 721, swivel 128 and line 129 through a pulley. Drawworks 130 is operated to control the weight on bit (“WOB”). The drill string 120 may be rotated by a top drive (not shown) instead of by the prime mover and the rotary table 7714. Alternatively, a coiled-tubing may be used as the tubing 722. A tubing injector 714a may be used to convey the coiled-tubing having the drilling assembly attached to its bottom end. The operations of the drawworks 730 and the tubing injector 714a are known in the art and are thus not described in detail herein.

A suitable drilling fluid 731 (also referred to as the “mud”) from a source 732 thereof, such as a mud pit, is circulated under pressure through the drill string 720 by a mud pump 734. The drilling fluid 731 passes from the mud pump 734 into the drill string 720 via a desurger 736 and the fluid line 738. The drilling fluid 731a from the drilling tubular discharges at the borehole bottom 751 through openings in the drill bit 750. The returning drilling fluid 731b circulates uphole through the annular space 727 between the drill string 720 and the borehole 726 and returns to the mud pit 732 via a return line 735 and drill cutting screen 785 that removes the drill cuttings 786 from the returning drilling fluid 731b. A sensor S₁ in line 738 provides information about the fluid flow rate. A surface torque sensor S₂ and a sensor S₃ associated with the drill string 720 respectively provide information about the torque and the rotational speed of the drill string 720. Tubing injection speed is determined from the sensor S₅, while the sensor S₆ provides the hook load of the drill string 720.

In some applications, the drill bit 750 is rotated by only rotating the drill pipe 722. However, in many other applications, a downhole motor 755 (mud motor) disposed in the drilling assembly 790 also rotates the drill bit 750. The rate of penetration (ROP) for a given BHA largely depends on the WOB or the thrust force on the drill bit 750 and its rotational speed.

The mud motor 755 is coupled to the drill bit 750 via a drive shaft disposed in a bearing assembly 757. The mud motor 755 rotates the drill bit 750 when the drilling fluid 731 passes through the mud motor 755 under pressure. The bearing assembly 757, in one aspect, supports the radial and axial forces of the drill bit 750, the down-thrust of the mud motor 755 and the reactive upward loading from the applied weight-on-bit.

A surface control unit or controller 740 receives signals from the downhole sensors and devices via a sensor 743 placed in the fluid line 738 and signals from sensors S₁-S₆ and other sensors used in the system 700 and processes such signals according to programmed instructions provided to the surface control unit 740. The surface control unit 740 displays desired drilling parameters and other information on a display/monitor 741 that is utilized by an operator to control the drilling operations. The surface control unit 740 may be a computer-based unit that may include a processor 742 (such as a microprocessor), a storage device 744, such as a solid-state memory, tape or hard disc, and one or more computer programs 746 in the storage device 744 that are accessible to the processor 742 for executing instructions contained in such programs. The surface control unit 740 may further communicate with a remote control unit 748. The surface control unit 740 may process data relating to the drilling operations, data from the sensors and devices on the surface, data received from downhole, and may control one or more operations of the downhole and surface devices. The data may be transmitted in analog or digital form.

The BHA 790 may also contain formation evaluation sensors or devices (also referred to as measurement-while-drilling (“MWD”) or logging-while-drilling (“LWD”) sensors) determining resistivity, density, porosity, permeability, acoustic properties, nuclear-magnetic resonance properties, formation pressures, properties or characteristics of the fluids downhole and other desired properties of the formation 795 surrounding the BHA 790. Such sensors are generally known in the art and for convenience are generally denoted herein by numeral 765. The BHA 790 may further include a variety of other sensors and devices 759 for determining one or more properties of the BHA 790 (such as vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc.) For convenience, all such sensors are denoted by numeral 759.

The BHA 790 may include a steering apparatus or tool 758 for steering the drill bit 750 along a desired drilling path. In one aspect, the steering apparatus may include a steering unit 760, having a number of force application members 761a-761n, wherein the steering unit is at partially integrated into the drilling motor. In another embodiment the steering apparatus may include a steering unit 758 having a bent sub and a first steering device 758a to orient the bent sub in the wellbore and the second steering device 758b to maintain the bent sub along a selected drilling direction.

The drilling system 700 may include sensors, circuitry and processing software and algorithms for providing information about desired dynamic drilling parameters relating to the BHA, drill string, the drill bit and downhole equipment such as a drilling motor, steering unit, thrusters, etc. Exemplary sensors include, but are not limited to drill bit sensors, an RPM sensor, a weight on bit sensor, sensors for measuring mud motor parameters (e.g., mud motor stator temperature, differential pressure across a mud motor, and fluid flow rate through a mud motor), and sensors for measuring acceleration, vibration, whirl, radial displacement, stick-slip, torque, shock, vibration, strain, stress, bending moment, bit bounce, axial thrust, friction, backward rotation, BHA buckling, and radial thrust. Sensors distributed along the drill string can measure physical quantities such as drill string acceleration and strain, internal pressures in the drill string bore, external pressure in the annulus, vibration, temperature, electrical and magnetic field intensities inside the drill string, bore of the drill string, etc. Suitable systems for making dynamic downhole measurements include COPILOT, a downhole measurement system, manufactured by BAKER HUGHES INCORPORATED.

The drilling system 700 can include one or more downhole processors at a suitable location such as 793 on the BHA 790. The processor(s) can be a microprocessor that uses a computer program implemented on a suitable non-transitory computer-readable medium that enables the processor to perform the control and processing. The non-transitory computer-readable medium may include one or more ROMs, EPROMs, EAROMs, EEPROMs, Flash Memories, RAMs, Hard Drives and/or Optical disks. Other equipment such as power and data buses, power supplies, and the like will be apparent to one skilled in the art. In one embodiment, the MWD system utilizes mud pulse telemetry to communicate data from a downhole location to the surface while drilling operations take place. The surface processor 742 can process the surface measured data, along with the data transmitted from the downhole processor, to evaluate formation lithology. While a drill string 720 is shown as a conveyance system for sensors 765, it should be understood that embodiments of the present disclosure may be used in connection with tools conveyed via rigid (e.g. jointed tubular or coiled tubing) as well as non-rigid (e. g. wireline, slickline, e-line, etc.) conveyance systems. The drilling system 700 may include a bottomhole assembly and/or sensors and equipment for implementation of embodiments of the present disclosure on either a drill string or a wireline. A point of novelty of the system illustrated in FIG. 7 is that the surface processor 742 and/or the downhole processor 793 are configured to perform certain methods (discussed below) that are not in prior art.

The term “information” as used herein includes any form of information (analog, digital, EM, printed, etc.). As used herein, a processor is any information processing device that transmits, receives, manipulates, converts, calculates, modulates, transposes, carries, stores, or otherwise utilizes information. In several non-limiting aspects of the disclosure, a processor includes a computer that executes programmed instructions for performing various methods. These instructions may provide for equipment operation, control, data collection and analysis and other functions in addition to the functions described in this disclosure. The processor may execute instructions stored in computer memory accessible to the processor, or may employ logic implemented as field-programmable gate arrays (‘FPGAs’), application-specific integrated circuits (‘ASICs’), other combinatorial or sequential logic hardware, and so on.

Thus, configuration of the processor may include operative connection with resident memory and peripherals for executing programmed instructions. In some embodiments, estimation of the parameter of interest may involve applying a model. The model may include, but is not limited to, (i) a mathematical equation, (ii) an algorithm, (iii) a database of associated parameters, or a combination thereof.

As used above, the term “sub” refers to any structure that is configured to partially enclose, completely enclose, house, or support a device. The one or more nuclear radiation sensors may be spaced at different distances along the tool (i.e., vertically offset). That is, for convenience, reference to the measurement occurring at a particular borehole depth refers to a particular reference point on the tool corresponding to measured depth of travel (e.g., the tool is considered to be at a particular depth). The term “information” as used above includes any form of information (analog, digital, EM, printed, etc.). The term “processor” herein includes, but is not limited to, any device that transmits, receives, manipulates, converts, calculates, modulates, transposes, carries, stores or otherwise utilizes information. A processor may include a microprocessor, resident memory, and peripherals for executing programmed instructions.

As used herein, radially offset, refers to a longitudinal axis of one detector being radially closer to the longitudinal axis of the borehole than another detector. Thus, radially offset detectors would also be non-coaxial (in terms of their own longitudinal axes) with respect to one another. Deconvolution may be any process to extract assumed components of a complex quantity. Deconvolution may be carried out using either a linear or non-linear weighted least squared error minimization technique, Monte Carlo techniques, simplex, neural network, and so on. Curve fitting, as used herein, may include linear or non-linear interpolation between values.

The term “predominantly” relates to an amount of detected radiation from a volume (e.g., the earth formation) relative to an amount of detected radiation from another volume (e.g., the borehole). A predominantly greater amount of detected radiation from the earth formation will provide a response that can be related to a property of the earth formation. As used herein, the term “predominantly” relates at least to a minimum amount of increase in detected radiation of a volume of interest of the formation with respect to other volumes, the minimum amount being necessary to be able to estimate a property of the earth formation at the volume of interest from the response.

Estimated parameters of interest may be stored (recorded) as information or visually depicted on a display. Aspects of the present disclosure relate to modeling a volume of an earth formation using the estimated parameter of interest, such as, for example, by associating estimated parameter values with portions of the volume of interest to which they correspond. The model of the earth formation generated and maintained in aspects of the disclosure may be implemented as a representation of the earth formation stored as information. The information (e.g., data) may be stored on a non-transitory machine-readable medium, and rendered (e.g., visually depicted) on a display.

Control of components of apparatus and systems described herein may be carried out using one or more models as described above. For example, at least one processor may be configured to modify operations i) autonomously upon triggering conditions, ii) in response to operator commands, or iii) combinations of these. Such modifications may include changing drilling parameters, steering the drillbit (e.g., geosteering), changing a mud program, optimizing measurements, and so on. Control of these devices, and of the various processes of the drilling system generally, may be carried out in a completely automated fashion or through interaction with personnel via notifications, graphical representations, user interfaces and the like. Reference information accessible to the processor may also be used.

The processing of the measurements by a processor may occur at the tool, or at a remote location. The data acquisition may be controlled at least in part by the electronics. Implicit in the control and processing of the data is the use of a computer program on a suitable non-transitory machine readable medium that enables the processors to perform the control and processing. The non-transitory machine readable medium may include ROMs, EPROMs. EEPROMs, flash memories and optical disks. The term processor is intended to include devices such as a field programmable gate array (FPGA).

While the present disclosure is discussed in the context of a hydrocarbon producing well, it should be understood that the present disclosure may be used in any borehole environment (e.g., a water or geothermal well).

While the foregoing disclosure is directed to the one mode embodiments of the disclosure, various modifications will be apparent to those skilled in the art. It is intended that all variations be embraced by the foregoing disclosure.

1. A method of evaluating an earth formation intersected by a borehole, the method comprising:
making a plurality of radiation measurements at plurality of borehole depths with a first gamma ray (GR) detector disposed on a carrier in the borehole and a second GR detector disposed on the carrier by positioning the first GR detector and the second GR detector in the borehole at each borehole depth such that the first GR detector is radially offset from the second GR detector with respect to the longitudinal axis of the borehole;
making an estimate of a concentration of at least one chemical element in the formation for each borehole depth for each of the first GR detector and the second GR detector from the plurality of measurements; and
estimating an actual concentration of the at least one chemical element using the estimates of the concentration for the first GR detector and the estimates of the concentration for the second GR detector for each borehole depth.

2. The method of claim 1 comprising:
estimating for each borehole depth a gamma ray spectrum for each of the first GR detector and the second GR detector;
making the estimate of the concentration for each borehole depth for each of the first GR detector and the second GR detector by deconvolving a corresponding gamma ray spectrum into a corresponding plurality of elemental spectral yields;
estimating the actual concentration by curve fitting the estimates of the concentration for the first GR detector with respect to the estimates of the concentration for the second GR detector for each borehole depth.

3. The method of claim 2, wherein deconvolving the corresponding gamma ray spectrum comprises using standards-based decomposition.

4. The method of claim 3, wherein a standard representing radiation of one of the at least one chemical element for the first GR detector is different than a standard representing radiation of the one of the at least one chemical element for the second GR detector.

5. The method of claim 1, wherein at least one of the gamma ray spectra is predominantly representative of naturally occurring radiation from the formation.

6. The method of claim 1, wherein the first detector is axially separated from the second detector.

7. The method of claim 1, wherein positioning the first GR detector and the second GR detector comprises eccentering the carrier in the borehole.

8. The method of claim 1, wherein the first detector is closer to a longitudinal axis of the borehole than the second detector, and the second detector is closer to a wall of the borehole than the first detector while making one of the plurality of radiation measurements.

9. The method of claim 8, wherein the tool includes radiation shielding positioned to prevent incident radiation from reaching a radiation-shaded portion of the first detector oriented toward the wall while allowing other incident radiation to reach a second portion of the first detector oriented toward the longitudinal axis.

10. The method of claim 8, wherein the tool includes radiation shielding positioned to prevent incident radiation from reaching a radiation-shaded portion of the second detector oriented toward the longitudinal axis while allowing other incident radiation to reach a second portion of the second detector oriented toward the wall.

11. The method of claim 1, wherein the radiation measurements of the first detector are predominantly representative of incident radiation from the borehole and the radiation measurements of the second detector are predominantly representative of incident radiation from the formation.

12. The method of claim 1, wherein the radiation measurements are substantially independent of a density of the formation.

13. The method of claim 1, comprising:
generating data points by plotting the estimates of the concentration for the first GR detector with respect to the estimates of the concentration for the second GR detector;
finding a line for the data points having a best fit;
determining a point on the line wherein the concentration for the first GR detector is equal to the concentration for the second GR detector.

14. An apparatus for evaluating an earth formation intersected by a borehole, the method comprising:
a tool configured to make a plurality of radiation measurements at plurality of borehole depths with a first gamma ray (GR) detector disposed on a carrier in the borehole and a second OR detector disposed on the carrier by positioning the first GR detector and the second GR detector in the borehole at each borehole depth such that the first GR detector is radially offset from the second GR detector with respect to the longitudinal axis of the borehole; and
at least one processor configured to:
make an estimate of a concentration of at least one chemical element in the formation for each borehole depth for each of the first GR detector and the second GR detector from the plurality of measurements; and
estimate an actual concentration of the at least one chemical element using the estimates of the concentration for the first GR detector and the estimates of the concentration for the second GR detector for each borehole depth.
